(19) United States
(12) Patent Application Publication
(10) Pub. No.: US 2021/0154693 A1
(43) Pub. Date: May 27, 2021

(54) METHOD AND APPARATUS FOR SPRAY PAINTING ANNULAR OBJECT

(71) Applicant: HENG FONG TECHNOLOGY CO., LTD., Tainan City (TW)

(72) Inventor: CHIN-YI CHENG, TAINAN CITY (TW)

(21) Appl. No.: 16/910,427

(22) Filed: Jun. 24, 2020

(30) Foreign Application Priority Data
Nov. 21, 2019 (TW) 108142379

(51) Int. Cl. B05B 13/02; B05D 1/02

(52) U.S. Cl. CPC B05B 13/0235; B05D 1/02; B05B 13/0292; B05B 13/0278

(57) ABSTRACT

The present invention discloses a method and an apparatus for spray painting an annular object. The annular object to be spray painted is placed and positioned on a loading tray disposed on a machine station and transported by a transporting mechanism along a spray painting path of the machine station. A self-rotation mechanism is turned on to automatically rotate the loading tray and the annular object to be spray painted. An air gun and a spray gun are turned on to remove dust on a disk surface of the annular object and spray paint the disk surface of the annular object to form a protection layer thereon.

### BACKGROUND OF THE INVENTION

### 1. Field of the Invention

The present invention relates to a method and an apparatus for spray painting an annular object, which prevents oxidation of the annular object in use, keeps a spray painting effect consistent and an outer ring frame surface of the annular object unpainted by a continuous process by the apparatus, and saves manufacturing time and cost.

### 2. Description of Related Art

Exercise bike is a kind of indoor sports equipment. People can exercise by using the exercise bikes at a single location in an indoor environment at any time without affecting by weather or the outdoor environment. Therefore, the exercise bike is popular and widely used by people. The structure and the exercise method of the traditional exercise bike are similar to the bike except that the exercise bike is used at a single location and the bike is movable.

Please referring to FIG. 8, an annular object (8) used for sporting equipment such as a flywheel, a feedback plate and a sensing aluminum ring usually comprises an axis portion, a disk surface (81) extended radially from the axis portion and a braking surface (82) for generating friction. The axis portion is assembled to an axle, and the braking surface (82) has correspondingly frictional resistance to a belt element. The disk surface (81) of the annular object (8) is easily oxidized due to exposure to the outer environment and air. Therefore, the disk surface (81) of the annular object (8) is coated with an anti-oxidation layer (9) in a last step for manufacturing the annular object (8). A traditional method to coat the anti-oxidation layer (9) on the disk surface (81) comprises the steps of pasting a masking tape (10) manually to the braking surface (82) of the annular object (8), spray painting an anti-oxidation paint on the disk surface (81), hot drying the anti-oxidation paint, and ripping off the masking tape (10). However, the traditional method comprises disadvantages described below.

1. Pasting the masking tape manually before spray painting and ripping off the masking tape manually after spray painting cost a lot of time and personnel cost.

2. In addition to spending time and manpower, the accuracy of pasting masking tape is not easily controlled since each worker uses different ways to paste the masking tape, resulting in inconsistent end product. If the braking surface is also painted with the anti-oxidation paint due to paste the masking tape inappropriately, the end product is considered as a defective product. In addition, if the pasting location of the masking tape deviated slightly, a defective product is also generated after the masking tape is ripped off, resulting in an increased defective rate.

3. The masking tape is expensive and can be used only once which increases production cost.

4. The production efficiency of the traditional method to coat the anti-oxidation layer is low and not cost-effective for its operation all done by manpower.

### SUMMARY OF THE INVENTION

The present invention discloses a method and an apparatus for spray painting an annular object which prevents oxidation of the annular object in use. The method for spray painting an annular object is operated by a continuously process by the apparatus and achieves effects of spray painting on the annular object consistently, keeping an outer ring frame surface of the annular object unpainted and saving manufacturing time and cost.

The method for spray painting an annular object and the apparatus used of the present invention are achieved by the following technical means.

The apparatus for spray painting an annular object of the present invention comprises a machine station, plural loading assemblies and a transporting mechanism disposed on the machine station for transporting the loading assemblies. An annular object to be spray painted is disposed and positioned on a loading tray of the load assembly and is transported by the transporting mechanism along a spray painting path of the machine station. A self-rotation mechanism is then turned on to automatically rotate the loading tray. An air gun is then turned on to remove dust on a disk surface of the annular object, and a spray gun is turned on to spray paint a paint on the disk surface of the annular object after dusting. Accordingly, a lateral disk surface of the annular object is evenly spray painted with a protection layer which prevents the annular object from oxidation in use. In addition, the method for spray painting the annular object of the present invention is operated by a continuously process by the apparatus to save manufacturing time. Furthermore, a spray painted location of the spray painting element of the present invention is adjustable corresponding to different annular objects to be spray painted, so the present invention also achieve effects of spray painting the annular object consistently and keeping an outer ring frame surface of the annular object unpainted.

### BRIEF DESCRIPTION OF THE DRAWINGS

FIG. 1 is a stereogram showing an apparatus for spray painting an annular object of the present invention;

FIG. 2 is a schematic diagram showing an annular object to be spray painted in an exploded state;

FIG. 3 is a schematic diagram showing a spray painting process of the present invention;

FIG. 4 is a lateral schematic diagram showing a dust removing process and a spray painting process of the present invention;

FIG. 5 is a partial enlarged schematic diagram showing a spray painting process of the present invention;

FIG. 6 is a top view showing a sensing process of a method for spray painting an annular object of the present invention;

FIG. 7 is a top view showing a sensing and repositioning process of a method for spray painting an annular object of the present invention;

FIG. 8 is a schematic diagram showing a traditional method for coating a protection layer on an annular object.

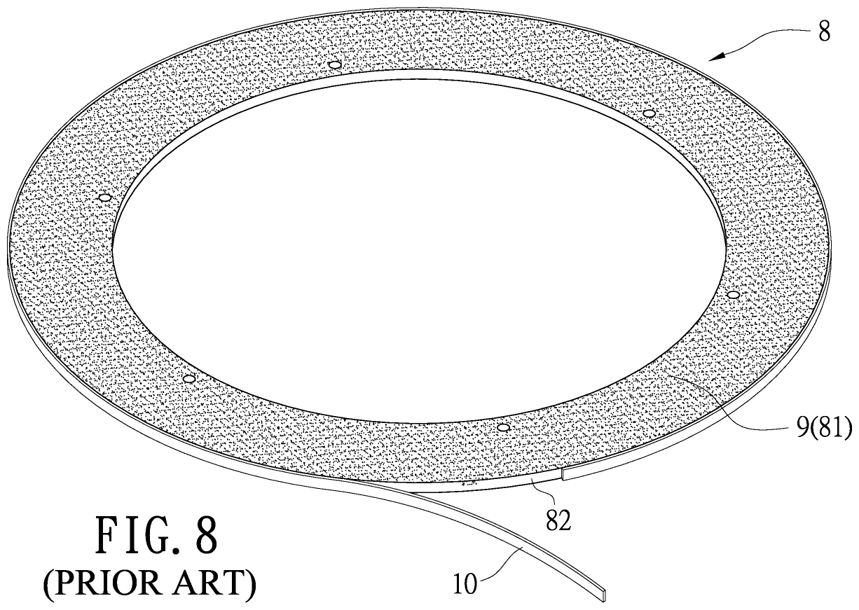

### DETAILED DESCRIPTION OF THE PREFERRED EMBODIMENT

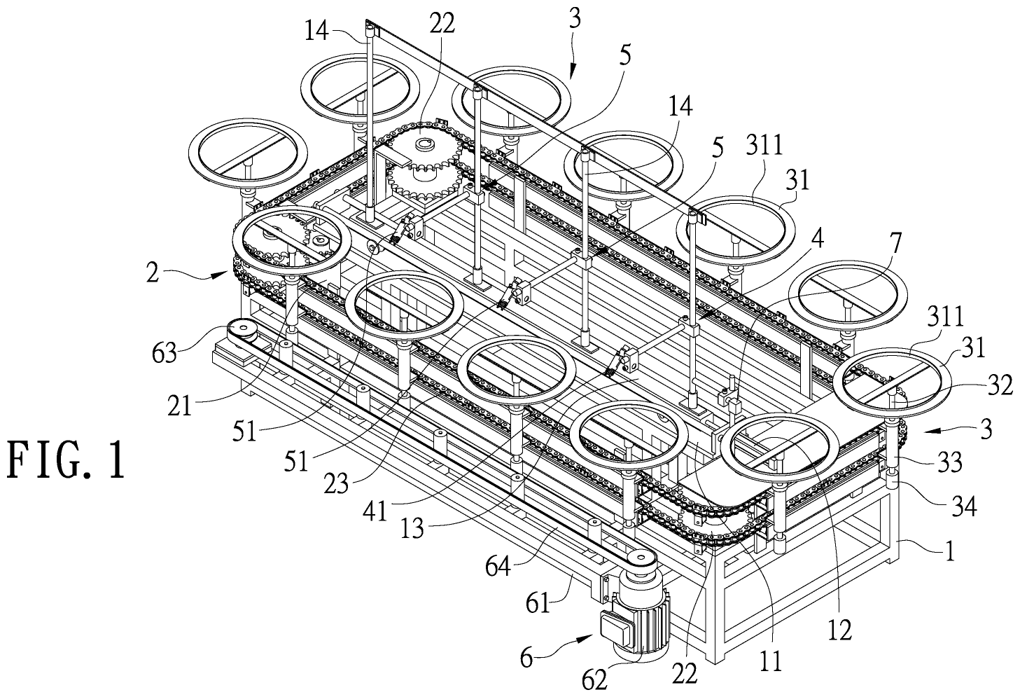

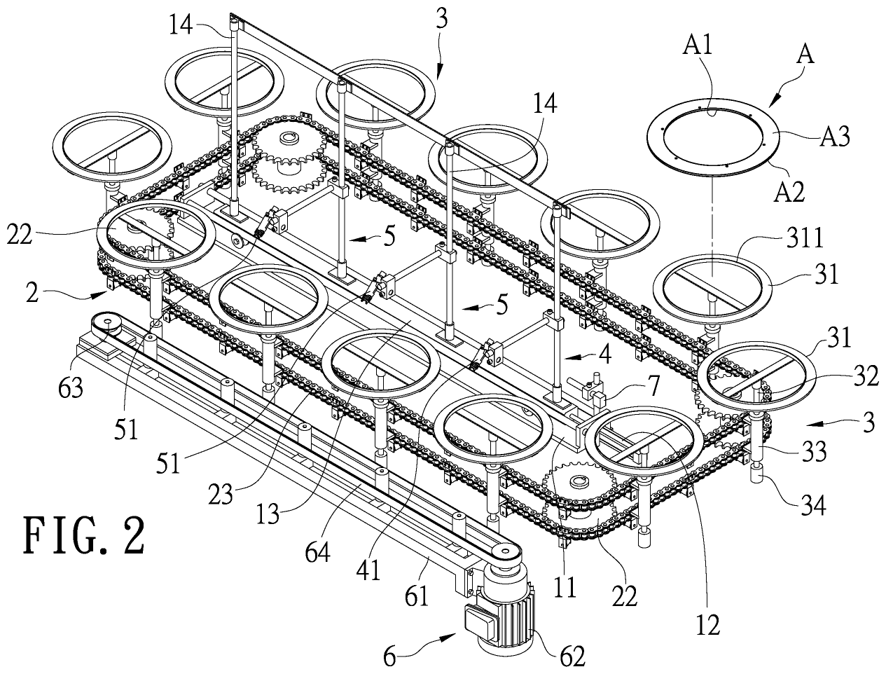

Referring to FIG. 1 and FIG. 2, a stereogram of the apparatus for spray painting an annular object of the present invention is disclosed which comprises a machine station (1), a transporting mechanism (2), plural loading assemblies (3), a dust removal element (4), at least one spray painting element (5), and a self-rotation mechanism (6).

The machine station (1) has a stand (11) thereon, a pushing source (12) connected to a terminal of the stand (11), a sliding element (13) connected to a terminal of the pushing source (12), and plural poles (14) disposed on the sliding element (13).

The transporting mechanism (2) is disposed on the machine station (1). The transporting mechanism (2) comprises a driving source (21), plural driven wheel assemblies (22) and a driving belt (23) engaged with the plural driven wheel assemblies (22). At least one of the plural driven wheel assemblies (22) is connected to and driven by the driving source (21), and the plural driven wheel assemblies (22) are rotated synchronously by the driving belt (23).

The plural loading assemblies (3) are used for loading the annular object (A) to be spray painted. Each of the plural loading assemblies (3) comprises a loading tray (31), a shaft (32) disposed in a middle of the loading tray (31), a shaft sleeve (33) surrounding the shaft (32) and connected to the driving belt (23) of the transmission mechanism (2) for positioning, and a rubbing member (34) disposed at a terminal of the shaft (32).

The dust removal element (4) has an air gun (41) disposed on one of the plural poles (14) of the machine station (1), and a location of the air gun (41) on the pole (14) is adjustable. The air gun (41) is used to blow a disk surface (A3) of the annular object (A) to be spray painted to remove the dust thereon.

The at least one spray painting element (5) is disposed adjacent to the dust removal element (4). The at least one spray painting element (5) has a spray gun (51), and the spray gun (51) is disposed on one side of the pole (14) of the machine station (1) adjacent to the dust removal element (4), and a location of the spray gun (51) on the pole (14) is adjustable. The spray gun (51) is used for spray painting a paint on the disk surface (A3) of the annular object (A) to be spray painted.

The self-rotation mechanism (6) is disposed at one lateral of the machine station (1) corresponding to the dust removal element (4) and the at least one spray painting element (5). The self-rotation mechanism (6) comprises a base (61), a power source (62) and a turning wheel (63) disposed on the base (61), and a dynamic friction belt (64) engaged with and disposed between the power source (62) and the turning wheel (63). The dynamic friction belt (64) contacts the rubbing member (34) of the loading assemblies (3) located corresponding to the dust removal element (4) and the at least one spray painting element (5) for driving the rubbing member (34) to automatically rotate the shafts (32) and the loading trays (31).

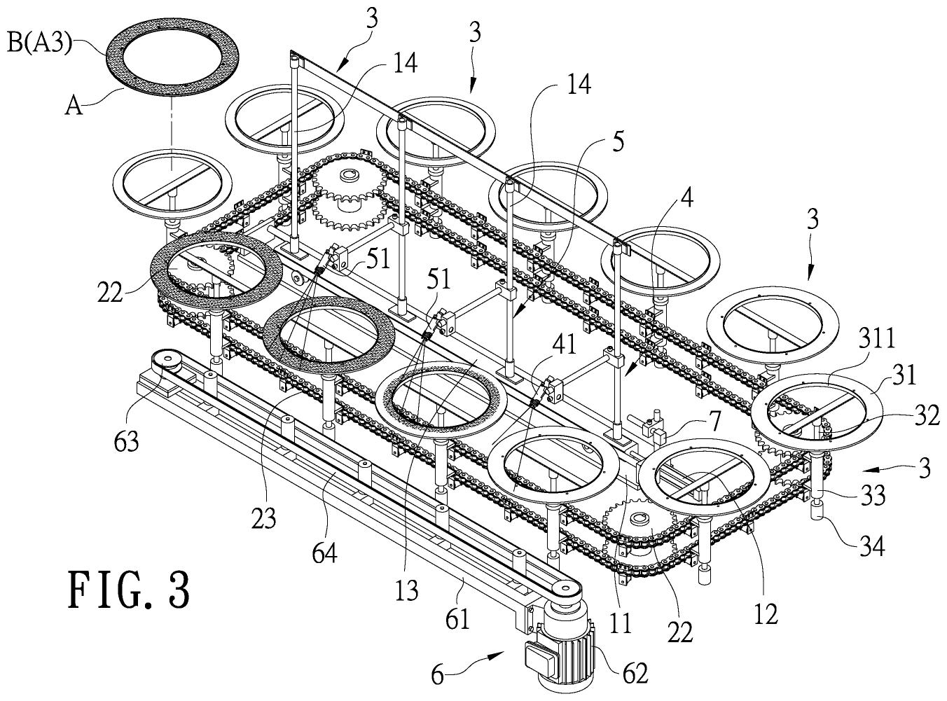

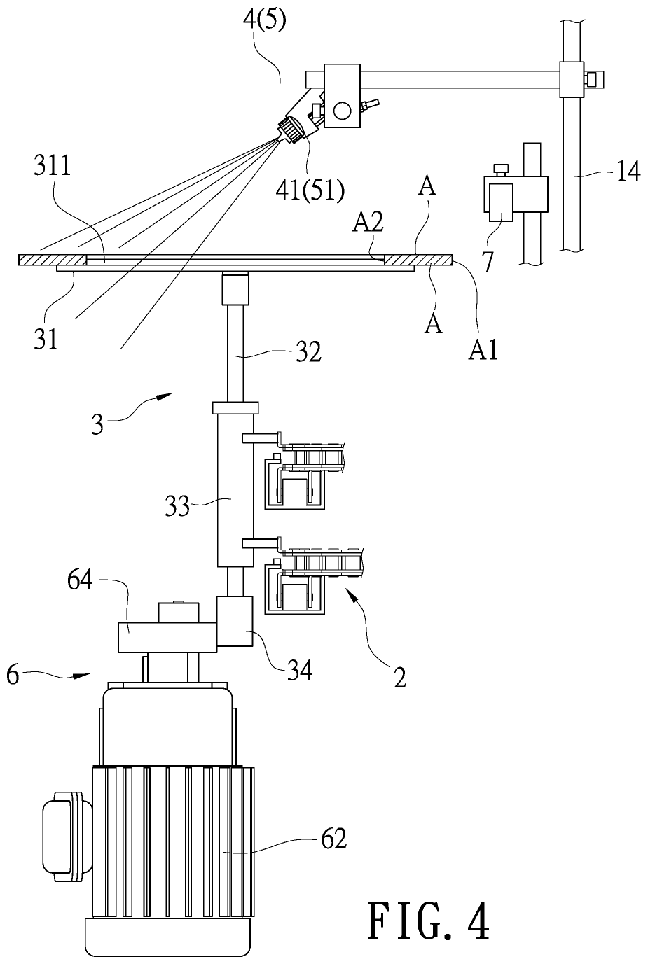

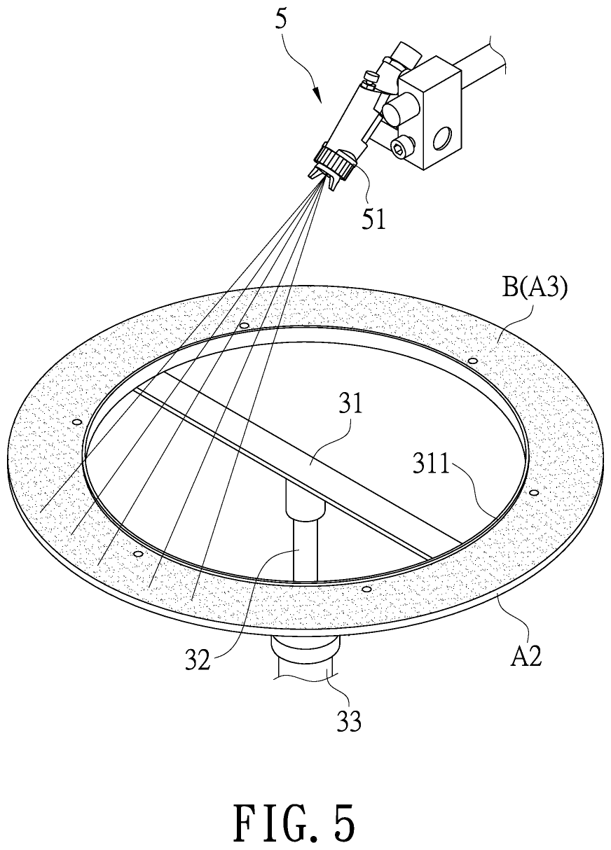

An annular object such as a flywheel, a rotating plate, a feedback plate or a sensing aluminum ring is generally used in sports equipment. Except for an outer ring frame surface for friction of the annular object (A), an outer disk surface thereof is spray painted with a protection layer (B) for anti-oxidation before installed on the sports equipment, and the disk surface (A3) of the annular object (A) is spray painted by the apparatus abovementioned and a method disclosed by FIG. 1 to FIG. 7. The method for spray painting an annular object of the present invention comprises the steps of:

(a) placing and positioning an annular object (A) to be spray painted on a loading tray (31), and transporting the loading tray (31) by a transporting mechanism (2) along a spray painting path of a machine station (1);

(b) turning on a self-rotation mechanism (6) to automatically rotate the loading tray (31) as the machine station (1) senses the annular object (A) to be spray painted, and turning on an air gun (41) to remove dust on a disk surface (A3) of the annular object (A) to be spray painted; and

(c) spray painting the disk surface (A3) of the annular object (A) to be spray painted with a paint in a rotating state by a spray gun (51) after removing dust thereon, and exporting the annular object (A) after spray painting.

First, the annular object (A) comprises an inner ring surface (A1), an outer ring frame surface (A2) and two lateral disk surfaces (A3). To spray paint the two lateral disk surfaces (A3) of the annular object (A), the annular object (A) is placed on the loading tray (31) of each of the plural loading assemblies (3). The loading tray (31) comprises an inner supporting edge (311) for engaging with the inner ring surface (A1) of the annular object (A) to be spray painted for stably positioning the annular object (A). Then, the plural loading assemblies (3) are driven to move by the transporting mechanism (2). In one embodiment of the present invention, the transporting mechanism (2) shown in the figures is a rectangular frame, the driving source (21) of the transporting mechanism (2) is disposed on the machine station (1), and the plural driven wheel assemblies (22) are disposed around the rectangular frame. The plural driven wheel assemblies (22) are rotated synchronously by engaging with the driving belt (23). The structure or the method of the present invention is not limited by the abovementioned embodiment, and any appropriate alternations or modifications to one having ordinary skills in the field should be considered as falling into the scopes of the present invention.

Furthermore, the transporting mechanism (2) disposed on the machine station (1) drives one of the driven wheel assemblies (22) engaged with the driving belt (23) by the driving source (21), and the other driven wheel assemblies (22) which are also engaged with the driving belt (23) are rotated synchronously. Therefore, the loading assemblies (3) engaged with the driving belt (23) are moved as the driving belt (23) is worked, and the loading trays (31) of the loading assemblies (3) are moved but not automatically rotated at this time. The loading assembly (3) passes through a sensor (7) installed on the stand (11) of the machine station (1) before dusting. When the sensor (7) senses the annular object (A) placed on the loading assembly (3), the air gun (41) of the dust removal element (4) will be turned on. At the same time, the loading assembly (3) is transported into the lateral of the machine station (1) where the self-rotation mechanism (6) is disposed. The turning wheel (63) of the self-rotation mechanism (6) is driven by the power source (62) to drive the dynamic friction belt (64), and the rubbing member (34) contacted the dynamic friction belt (64) is then driven by the dynamic friction belt (64). So, the shaft (32) of the loading assembly (3) is driven to rotate by the rubbing member (34) disposed at the terminal thereof, and the loading tray (31) connected to the shaft (32) is driven to automatically rotate.

When the loading tray (31) in an automatically rotation state is transported to the dust removal element (4), dust on the disk surface (A3) of the annular object (A) to be spray painted is blown away by the air gun (41) of the dust removal element (4). After dusting, the loading tray (31) in an automatically rotation state is continuously transported to the spray painting element (5) for spray painting. The annular object (A) placed on the loading tray (31) passes through the spray painting element (5), and the disk surface (A3) of the annular object (A) is spray painted with a paint by the spray gun (51).

The amount of the spray painting element (5) installed on the apparatus for spray painting an annular object of the present invention is determined by a diameter or a width of the annular object (A) to be spray painted. A spraying range of each spray gun (51) is adjustable, and a spraying location sprayed by the spray gun (51) disposed on the poles (14) and a blowing location blown by the air gun (41) disposed on the poles (14) are also adjustable. In an embodiment, the disk surface (A3) of the annular object (A) is defined as an inner area and an outer area, and the apparatus for spray painting an annular object of the present invention has two spray painting elements (5) for respectively spray painting the inner area and the outer area. The annular object (A) is passed through the spray gun (51) in an automatically rotated state for spray painting the disk surface (A3), and the annular object (A) is exported after spray painting.

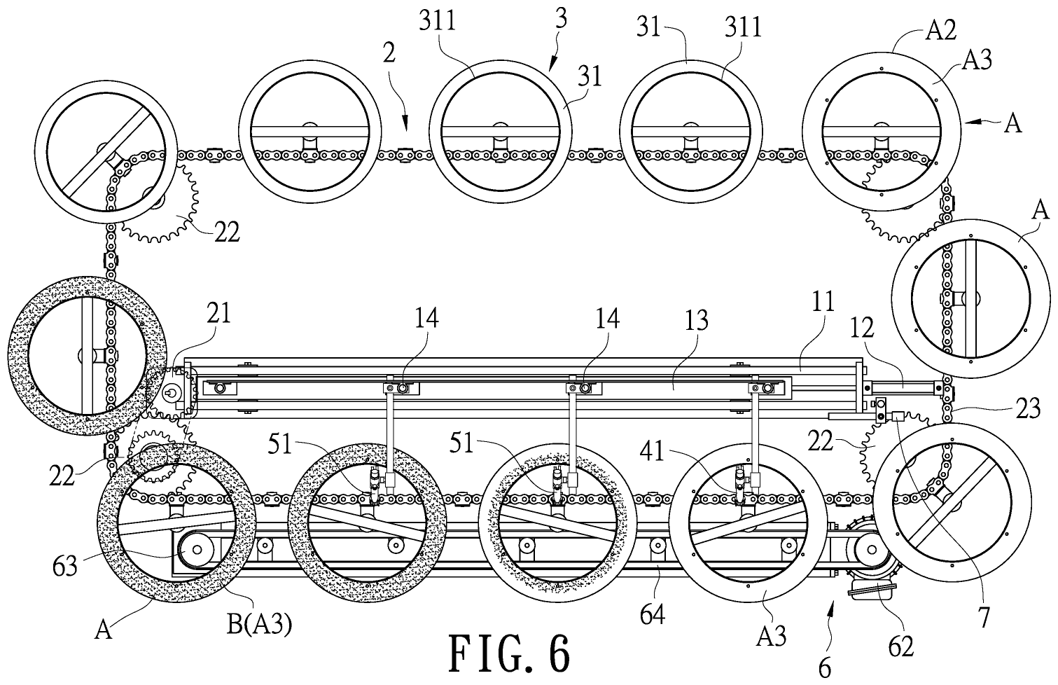

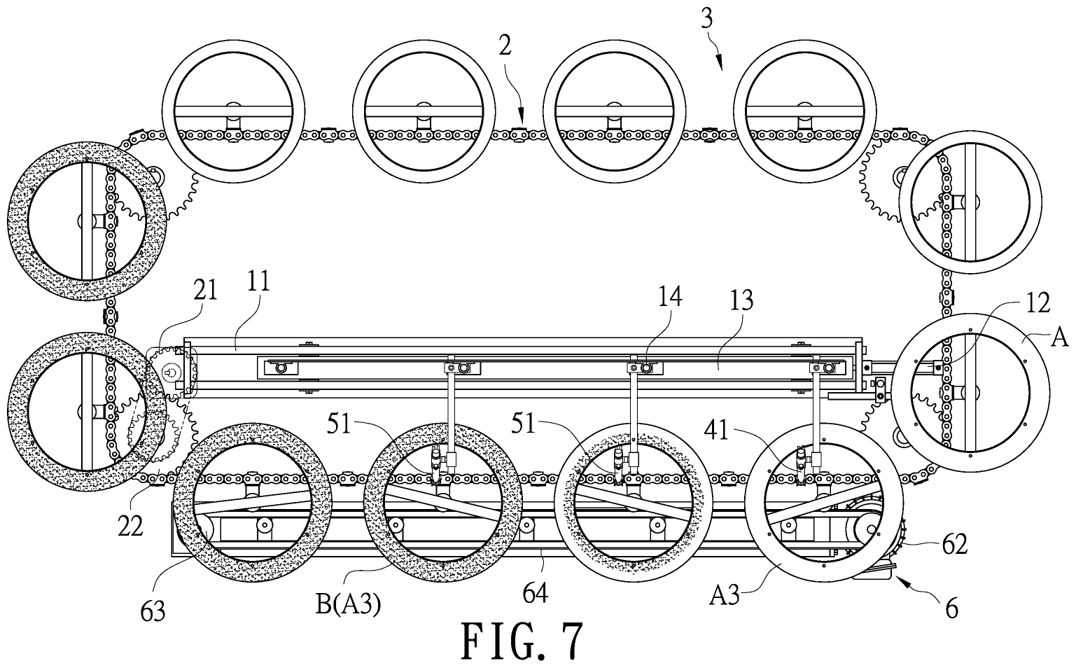

Referring to FIG. 6 and FIG. 7, it is worth to explain that the annular object (A) placed on the loading tray (31) of the loading assembly (3) is continuously transported forwardly when dusting and spray painting the annular object (A), and the dust removal element (4) and the spray painting element (5) are moved synchronously with the loading tray (31) containing the annular object (A). The air gun (41) and the spray gun (51) disposed on the plural poles (14) of the machine station (1) are drive to move along the loading trays (31) containing the annular object (A) for dusting and spray painting by the pushing source (12) of the machine station (1) in which the pushing source (12) pushes the sliding element (13) and the plural poles (14) connected to the sliding element (13). The dust removal element (4) and the spray painting element (5) are then repositioned for dusting and spray painting another annular object (A) when the sensor (7) senses the another annular object (A) to be spray painted transported into the dust removal element (4).

The abovementioned apparatus for spray painting an annular object just sprays one disk surface (A3) of the annular object (A) to be spray painted, and the spray painting apparatus of the present invention can be further connected to a drying or roasting apparatus (not shown in the figures) for drying the spray painted layer on one disk surface (A3) of the annular object (A). The annular object (A) is then turned over for spray painting the other disk surface (A3) by the apparatus of the present invention. In addition to prevent oxidation, the protection layer (B) formed on the disk surface (A3) of the annular object (A) also can be formed by a colorful paint to achieve a beautiful visual effect.

Accordingly, the method for spray painting an annular object of the present invention is operated by a continuously process by the apparatus which saves manufacturing time. The spray painting location by the spray painting element (5) of the present invention is adjustable corresponding to paint different annular objects (A) which achieves effects of spray painting on the disk surface (A3) efficiently and consistently to form the protection layer (B), and keeping the outer ring frame surface (A2) of the annular object (A) unpainted.

What is claimed is:

1. An apparatus for spray painting an annular object, comprising:
a machine station having a stand thereon, a pushing source connected to a terminal of the stand, a sliding element connected to a terminal of the pushing source, and plural poles disposed on the sliding element;
a transporting mechanism disposed on the machine station and having a driving source, plural driven wheel assemblies and a driving belt engaged with the plural driven wheel assemblies, wherein one of the plural driven wheel assemblies is connected to and driven by the driving source, and wherein the plural driven wheel assemblies are rotated synchronously by the driving belt;
plural loading assemblies for loading the annular object to be spray painted, wherein each of the plural loading assemblies comprises a loading tray, a shaft disposed in a middle of the loading tray, a shaft sleeve surrounding the shaft and connected to the driving belt of the transmission mechanism for positioning, and a rubbing member disposed at a terminal of the shaft;
a dust removal element having an air gun disposed on one of the plural poles of the machine station for blowing a disk surface of the annular object to be spray painted to remove dust thereon; wherein a location of the air gun on the pole is adjustable;
at least one spray painting element disposed on one side of the plural poles of the machine station adjacent to the dust removal element and having a spray gun for spray painting the disk surface of the annular object to be spray painted to form a protection layer thereon, wherein a location of the spray gun on the another pole is adjustable; and
a self-rotation mechanism disposed at one lateral of the machine station corresponding to the dust removal element and the at least one spray painting element and having a base, a power source and a turning wheel disposed on the base, and a dynamic friction belt engaged with and disposed between the power source and the turning wheel, wherein the dynamic friction belt contacts the rubbing members of the loading assemblies located corresponding to the dust removal element and the at least one spray painting element for driving the rubbing members to automatically rotate the shafts and the loading trays.

2. The apparatus for spray painting an annular object as claimed in claim 1, wherein the stand is provided with a sensor at a front region of the dust removal element for sensing a location of the loading tray of the loading assembly and controlling operation of the air gun of the dust removal element, the spray gun of the spray painting element and the pushing source.

3. The apparatus for spray painting an annular object as claimed in claim 2, wherein the loading tray comprises an inner supporting edge for engaging with an inner annular surface of the annular object to be spray painted for positioning.

4. The apparatus for spray painting an annular object as claimed in claim 1, wherein the spray painting apparatus is further connected to a drying or roasting apparatus for receiving the annular object after spray painted and drying the protection layer.

5. A method for spray painting an annular object by using the apparatus for spray painting an annular object as claimed in claim 1, comprising the steps of:
placing and positioning an annular object to be spray painted on a loading tray, and transporting the loading tray by a transporting mechanism along a spray painting path of a machine station;
turning on a self-rotation mechanism to automatically rotate the loading tray and the annular object to be spray painted as the machine station senses the annular object to be spray painted, and turning on an air gun for removing dust on a disk surface of the annular object to be spray painted; and
spray painting the disk surface of the annular object to be spray painted with a paint in a rotating state after removing dust thereon by a spray gun, and exporting the annular object after spray painting.

6. The method as claimed in claim 5, wherein the loading tray is continuously transported forwardly when removing dust on the annular object and spray painting the annular object, and the air gun and the spray gun are moved synchronously with the loading tray containing the annular object, wherein the air gun and the spray gun are disposed on plural poles of the machine station, and wherein the sliding element of the machine station connected to the plural poles is pushed by the pushing source of the machine station to drive the air gun and the spray gun moving along the loading trays.

7. An annular object prepared by a method as claimed in claim 5, wherein the annular object comprises an inner ring surface, an outer ring frame surface and two lateral disk surfaces, and wherein each of the two lateral disk surfaces is spray painted with a protection layer.
